(19) United States
(12) Patent Application Publication
(10) Pub. No.: US 2025/0121574 A1
(43) Pub. Date: Apr. 17, 2025

(54) DEVICE FOR COMPRESSING AND TYING UP RECYCLING BALES AND METHOD FOR TYING UP RECYCLING BALES USING SUCH A DEVICE

(71) Applicant: Avermann Maschinenfabrik GmbH & Co. KG, Osnabrück (DE)

(72) Inventor: Bülent Sendallar, Hasbergen (DE)

(21) Appl. No.: 18/912,757

(22) Filed: Oct. 11, 2024

(30) Foreign Application Priority Data
Oct. 16, 2023 (DE) 10 2023 128 236.0

(51) Int. Cl. B30B 9/30

(52) U.S. Cl. CPC B30B 9/3021; B30B 9/3057

(57) ABSTRACT

A device for compressing and tying up recycling bales with tying means includes a baling channel and a baling ram mounted for translational motion in the baling channel. The baling ram has a channel for guiding a vertically movable tying tool that transports a tying means, guiding the tying means below the baling channel, around at least one deflector, and over the guide contour of a guide element. The device has a swivel arm which, during normal operation of the device, is in a guiding position in which the tying means is guided along the at least one deflector and over the guide contour of the guide element in a sliding motion. The swivel arm has a gripping device on the tying means side for the automated fixing of a free end of a torn-off piece of tying means.

### DESCRIPTION

The invention relates to a device for compressing and tying up recycling bales and a method for tying up recycling bales using such a device.

A device for compressing and tying up recycling bales with tying means is already known from EP 1 254 840 B1, which comprises a baling channel and a baling ram that is mounted in such a way as to be movable in a translational motion in the baling channel. The materials to be processed can vary widely. For example, the recycling bales can consist of waste materials, wastepaper, but also of metals or mixed materials, which are compacted under the high pressure of the baling ram within the baling channel. For the purpose of tying up the compressed recycling bales, the baling ram has a channel on its face side for guiding a tying tool that transports a tying means and can be moved vertically or, in some designs, also or additionally horizontally. The wall openings of the baling channel, through which the tying tool can be guided in a defined pressing position of the baling ram to apply ties from the tying means around the recycling bale held by the baling ram in the pressing position, are aligned with these channels in the baling ram. The tying means can thereby be closed with a tying means loop guided through the baling ram behind the recycling bale. The tying means, which is usually provided by a stock roll, is guided over at least one deflector. In the known design, rotatably mounted rollers are used as deflectors.

To guide the tying means, for example, a method also known from EP 3 333 089 B1 is to guide the tying means through grooves, while DE 25 40 452 A1 provides for guidance in channels. In particular, rollers are currently used as deflectors. One example of such a solution is found in DE 10 2020 121 898 A1.

The individual components of such devices and also the tying means used are subject to considerable loading caused by impurities and the considerable pressures that occur when the recyclable materials are processed into recycling bales. In practice, therefore, it is often the case that individual strands of tying means tear, preventing the recycling bale from being properly wrapped. EP 1 683 408 B1 describes a solution for detecting such tears in the tying means, whereby a tension is applied to the tying means by means of a weight pack on the tying means and a thread brake. An approximation sensor referred to in the publication as a “break sensor” detects a break in a tying means by registering the falling of the weight pack. However, the device must always be stopped when the tying means is torn so that the processing is stopped in order to manually replace the defective tying means with a new one. This is not only an unpleasant and time-consuming task for the user, but also poses a significant risk of injury, since the tying means are guided within or below the machine bed.

The underlying task of the invention is to replace a torn tying means almost entirely automatically in a device for compressing and tying up recycling bales. Furthermore, a method must be specified for how the replacement of the tying means can be carried out with such a device.

The invention solves this task with the features of the independent patent claims 1 and 12. Further embodiments of the invention are the subject of the respective subsequent subclaims.

A device for compressing and tying up recycling bales with tying means, wherein the device for compressing the recycling bales comprises a baling channel and a baling ram that is mounted in such a way that it can be moved in a translational motion in the baling channel and that has a channel on its face side for guiding a vertically movable tying tool that transports a tying means for tying up the compressed recycling bales, each tying means being guided below the baling channel around at least one deflector and over the guide contour of a respective guide element, has been further developed in accordance with the invention in that the device has at least one swivel arm that is mounted so that it can rotate along a linear guide or around an axis of rotation, which, during the normal operation of the device, is in a guiding position in which the tying means, each fed through a tube or a slot, are guided along in a sliding motion on the at least one deflector assigned to the guide contour of the guide element and on the surface of the associated guide element, with each swivel arm having a gripping device on the tying means side for the automated fixing of a free end of a torn-off tying means.

The inventive feature is to be seen in this case in the fact that, when a tying means is torn off, each of the gripping devices on the device automatically grasps the replacement tying means supplied via the tube or slot and transfers it to a position that allows the process of tying up the recycling bales with tying means to be continued. The device is therefore a means to minimize the interruption of the continuous production of the recycling bales, since the end of the tying means following the torn-off tying means is gripped immediately by the gripping device, making it available for further processing. The entire process is thus largely automated, thereby eliminating the need for a laborious and time-consuming manual replacement of the torn-off tying means.

According to a first embodiment of the invention, it is proposed that a plurality of synchronously moving swivel arms form a swivel unit that can swivel along the linear guide or about a shared axis. In other words, not only a single swivel arm is moved, but all swivel arms are moved simultaneously when one of the tying means present is torn. The swivel arms are preferably rotatably mounted around a shared axis of rotation. The formation of a swivel unit can, therefore, simplify the control of the entire device, as then not every swivel arm has to be controlled separately. This also results in reduced complexity with regard to the required mechanics and hydraulics, enabling a very important improvement of known devices for compressing and tying up recycling bales.

According to a highly advantageous further development of the invention, the gripping device of each swivel arm has a clamping jaw that is mounted in such a way that it can swivel around an axis and whose clamping surface is pressurized by activating the gripping device by means of an extendable ram of a ram-cylinder unit or an electromagnet on the underside of the guide element, which is opposite the guide contour for guiding the tying means and forms a pressure surface. Consequently, the gripping device of each swivel arm consists of a ram-cylinder unit, the clamping jaw with the clamping surface formed on it and the guide element with the pressure surface corresponding to the clamping surface, which is formed on the underside of the guide element. The gripping device thus forms a kind of pincer shape that is able to grasp and fix a free end of a tying means in place.

It is particularly important that when a tying means is torn off, the swivel unit is transferred from its original guiding position to a clamping position in which the swivel arms assume a position in which the intact tying means are guided over the surface of the guide elements under a preload and the tying means that is fed in via the tube or the slot is clamped between the pressure surface on the underside of the guide element and the clamping surface of the clamping jaw. In this way, the normal operation of the tying means that has not been torn off can be continued or maintained, while the newly supplied tying means is gripped by the gripping device and fixed by a clamp.

After the replacement tying means has been fixed in place as described above, the end of the new tying means fed over the tube or slot and fixed by the gripping device is transferred by means of the swivel arm from the clamping position back to the guiding position and initially held in the guiding position. In this state, the tying means spans a free space so that the tying tool is able to grasp the tying means and feed it to a knotting or twisting device, where it is knotted or twisted, allowing normal operation of the device to be continued immediately afterwards.

For the design of the gripping device, it is of particular importance that the underside of the guide element has a pressure surface complementary to the clamping surface of the clamping jaw. This has the consequence that a form fit capable of receiving the tying means is present between the pressure surface on the underside of the guide element and the clamping surface of the clamping jaw. The form fit allows the tying means to be optimally and reliably fixed.

As already mentioned above, the devices according to the invention for compressing and tying up recycling bales are used, for example, to produce recycling bales from waste. This means that significant contamination can occur in the area of the baling channel and below the machine bed due to falling residues of the recyclable materials or escaping moisture. The fact that the swivel arms are protected from contamination by a protective plate, therefore, represents a highly advantageous design feature of the invention. Here, a particularly preferred design of the protective plate would be a single piece, which would protect the entire swivel unit in its entirety. Naturally, it is also in line with the purpose of the invention for each individual swivel arm to be protected from contamination by a separate protective plate.

In order to facilitate the feeding of the tying means that replaces the torn-off tying means, it is advantageous for a guiding device for feeding the tying means to be arranged at the outlet of the tube or slot feeding the tying means. In a particularly preferred embodiment, the guiding device should taper conically in the direction of the swivel arms or, to put it in more general terms, should have a tapering shape. This allows the supplied tying means to be guided into the area of the gripping device in a targeted way, which significantly reduces the time required to replace the tying means and makes it easier for the gripping device to grasp the tying means.

The method according to the invention for tying up recycling bales using a device as described above is characterized in that, when at least one tying means is torn, the swivel arms of the swivel unit, which are in a guiding position during the normal operation of the device, are transferred synchronously from the guiding position to the clamping position, in which the undamaged tying means continue to be guided under pretension over the surface of the guide element, while the replacement tying means that is fed in is grasped and clamped in the clamping position through the activation of the gripping device between the pressure surface on the underside of the guide element and the clamping surface of the clamping jaw, and by a subsequent return movement of the swivel unit to the guiding position, this tying means spans a free space so that the tying tool grasps the replaced tying means by means of a vertical lifting movement and feeds it to a knotting or twisting device.

With the method according to the invention, a torn tying means can be replaced easily and in an almost entirely automatic process with only a brief interruption or during the operation of the device. This results in a significant reduction in downtime and in the prevention of defective recycling bales. Complex sensor technology or mechanics are not required to achieve this. The device for compressing and tying up recycling bales is very simple and thus also cost-effective thanks to the method according to the invention.

The action of grasping the newly supplied tying means as a replacement for the torn tying means creates a remainder which, in accordance with a further development measure applied to the method, is separated after the knotting or twisting to allow the continuation of the normal operation of the device.

The invention will be explained in greater detail below with reference to the accompanying drawings. The example shown does not represent a restriction to the illustrated embodiment, but rather serves only to explain a principle of the invention.

Identical or similar components are always designated by the same reference numbers. In order to illustrate the mode of operation according to the invention, the figures only show highly simplified schematic diagrams in which the components that are not essential for the invention have been omitted. However, this does not mean that such components are not present in a solution according to the invention.

The following are shown in the figures:

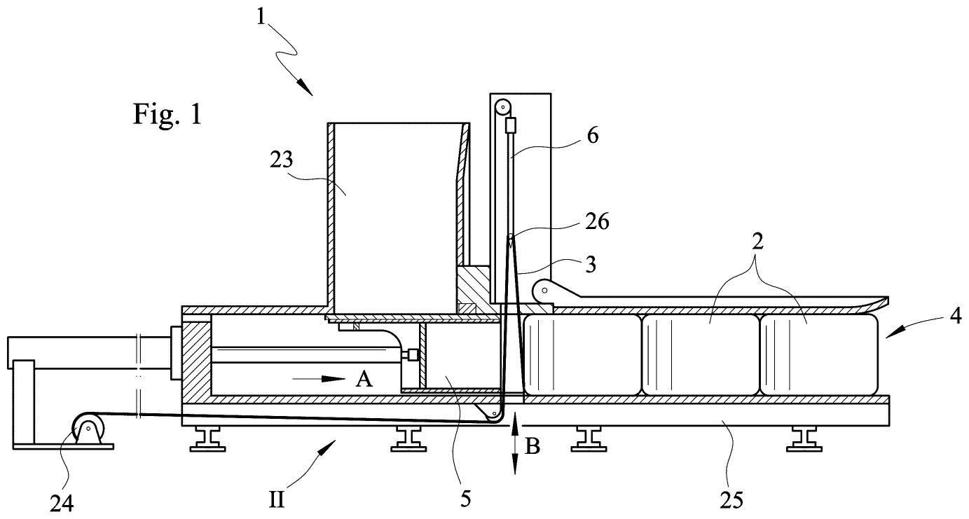

FIG. 1: a schematic diagram of a device for compressing and tying up recycling bales,

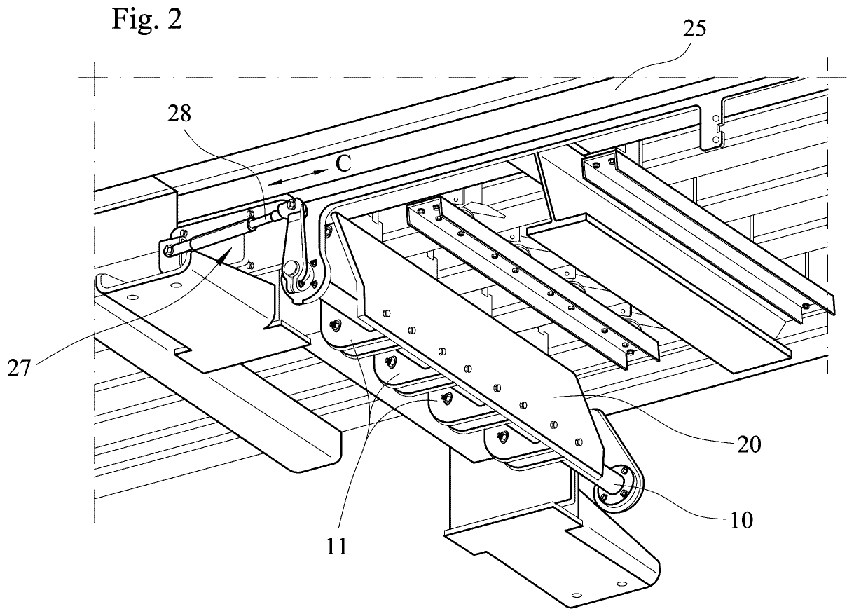

FIG. 2: a view of the underside of the machine bed of a device as shown in the direction of arrow II in FIG. 1,

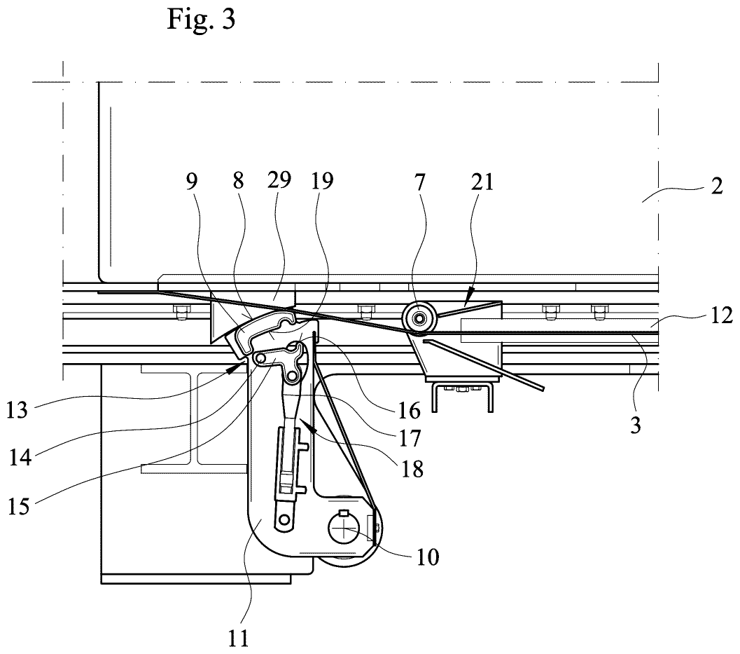

FIG. 3: the guidance of an intact tying means during the normal operation of the device without a torn tying means,

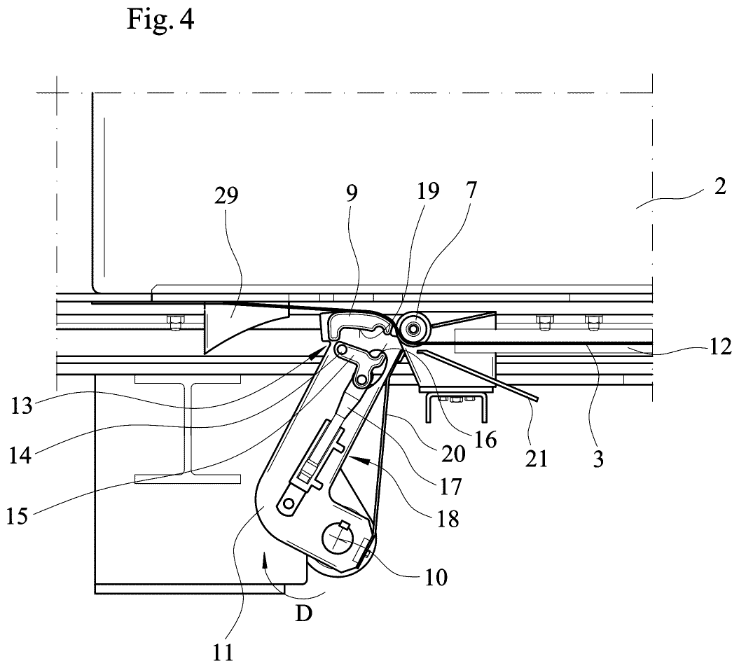

FIG. 4: the guidance of an intact tying means while a tying means not shown is torn off,

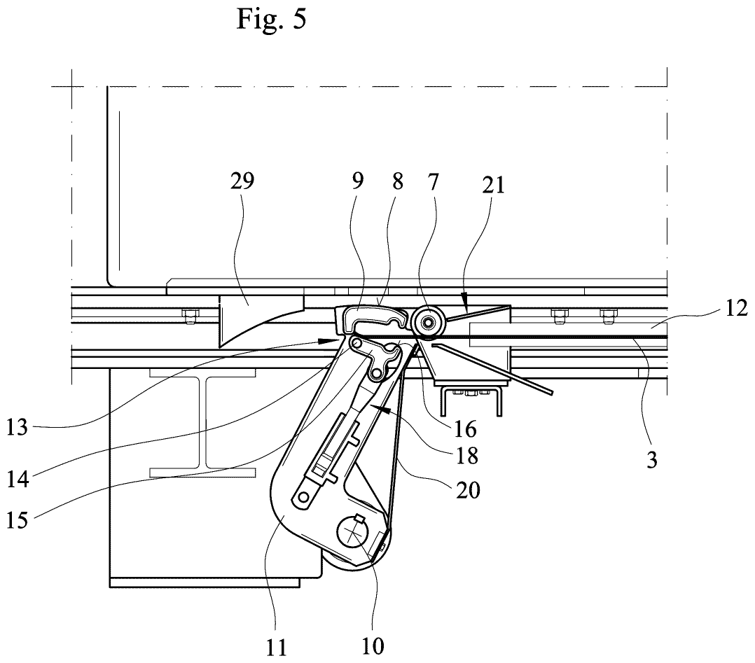

FIG. 5: the position of a swivel arm in the event of a torn off tying means with an open gripping device,

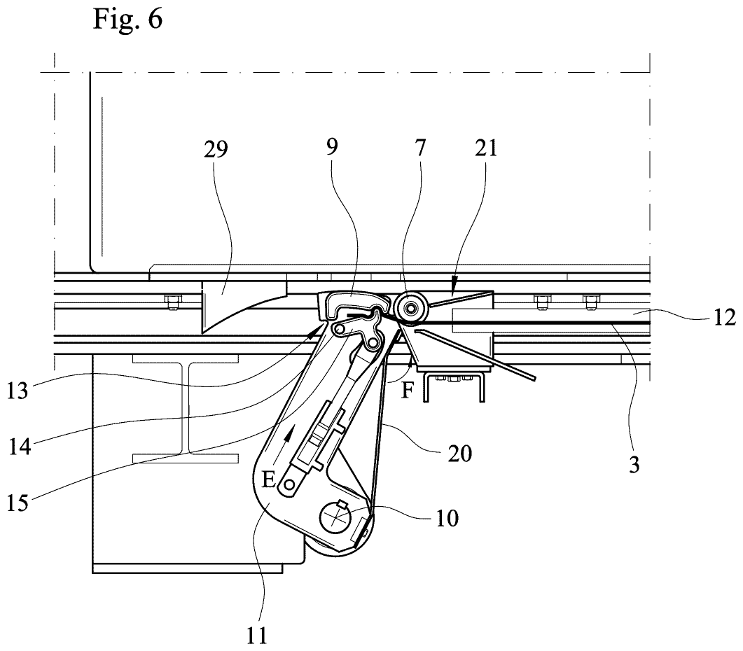

FIG. 6: the position of a swivel arm in the case of a torn-off tying means with the gripping device closed,

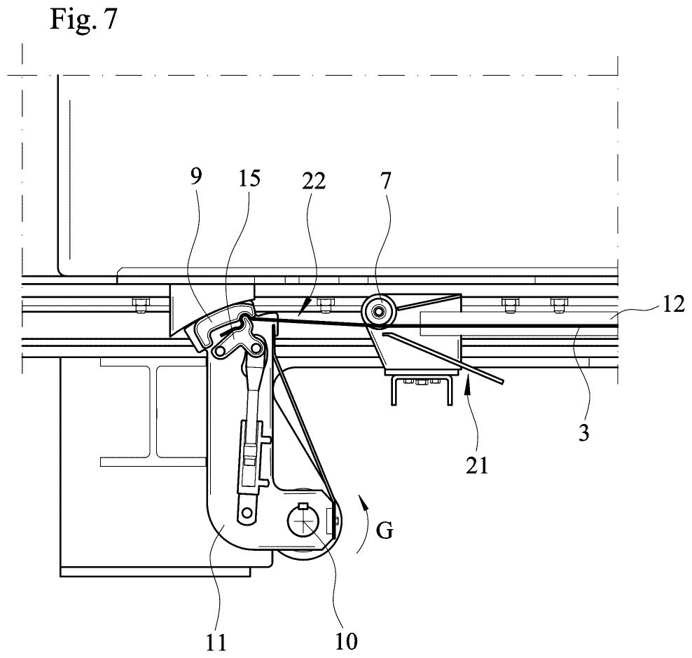

FIG. 7: the return of the swivel arm to the guiding position,

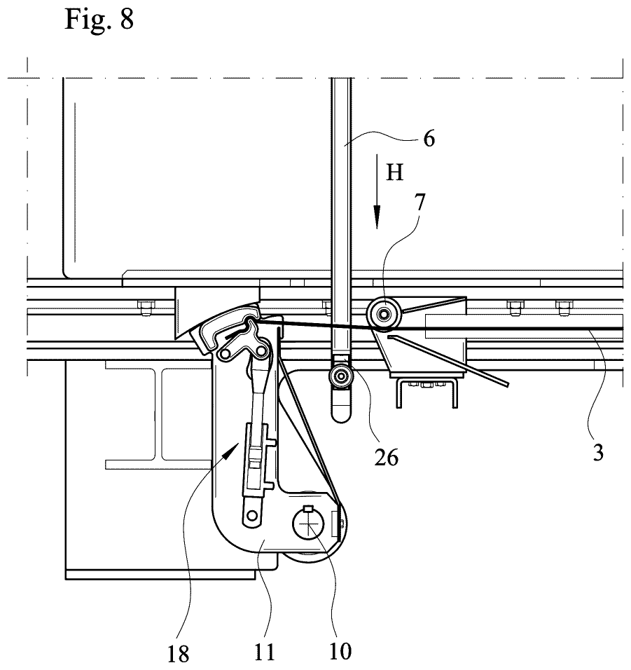

FIG. 8: the free space spanned by the tying means with the tying tool lowered,

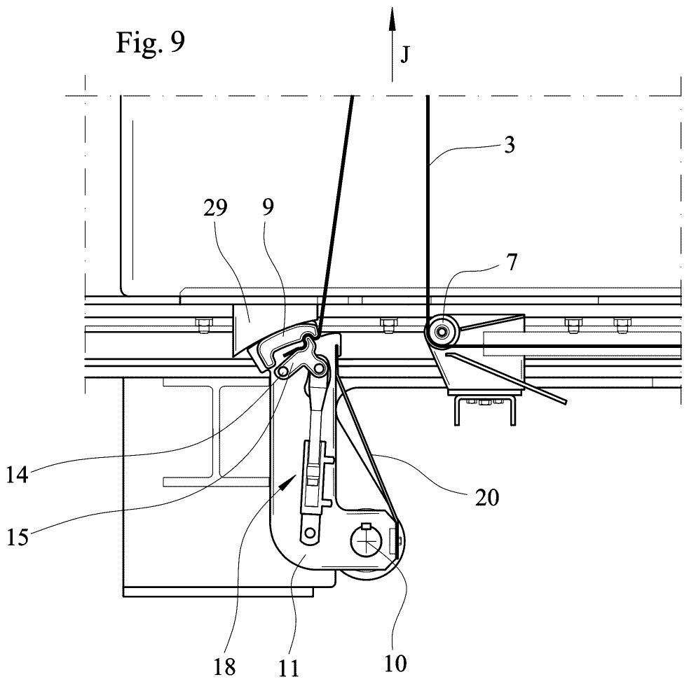

FIG. 9: the movement of the tying tool for knotting or twisting the tying means, and

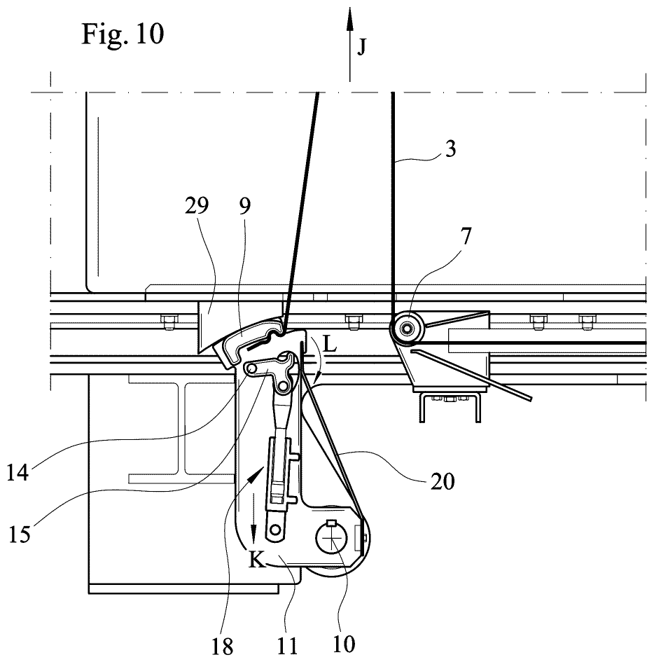

FIG. 10: the release of the tying means by the gripping device for the further processing of the recycling bales.

First, FIG. 1 illustrates a highly generalized schematic diagram of a known device 1 for compressing and tying up recycling bales 2 with a tying means 3 in which the special feature of the invention cannot be recognized in detail. Such devices 1 include a baling channel 4 in which a baling ram 5 is movably guided in the longitudinal direction, i.e. in translational motion. The baling ram 5 is driven by a suitable hydraulic device and generates a pressing power that compacts the recyclable materials supplied to the baling channel 4 via the filling shaft 23 and moves them in the direction of arrow A. The entire device 1 has a machine bed 25 that is mounted on the ground via a suitable supporting structure. In order to tie up the compressed recycling bales 2, the baling ram 5 has a channel on its bale-side face side for guiding a vertically movable tying tool 6, each for a channel designed for this purpose, whereby each tying means 3 is guided below the baling channel 4 around at least one deflector 7 and over the guide contour 8 of a guide element 9 in each case. The tying means 3 supplied from a stock roll 24 is grasped by a barbed hook 26 present on the tying tool 6 and, by means of a vertical movement in the direction of arrow B, is supplied to a knotting or twisting device.

Based on the schematic structure of a device 1 for compressing and tying up recycling bales 2 as shown in FIG. 1, FIG. 2 allows a view in the direction of arrow II from FIG. 1 onto the underside of the machine bed 25 of a device 1 according to the invention. This view already reveals a special feature in the present case, namely that multiple swivel arms 11 arranged coaxially, i.e. on a shared axis of rotation 10, are mounted by a shared hydraulic unit 27 with a ram 28 so that they can rotate and swivel around the axis of rotation 10. The ram 28 of the hydraulic unit 27 is moved back and forth in the direction of the double arrow C to move the swivel arms 11. To protect the bearings and the hydraulic unit 27, the swivel unit formed by the swivel arms 11 has a protective plate 20.

FIG. 3 illustrates the normal operation of the device 1 with an intact tying means 3, i.e. without a torn tying means 3. In addition, one of the swivel arms 11 of the swivel unit is shown in a side view. The special feature of the invention is that the swivel arm 11, which is rotatably mounted about the axis of rotation 10, has a gripping device 13, which, in the present case, consists of a ram-cylinder unit 18 with an extendable ram 17 that engages a clamping jaw 15 and moves the latter by its movement about an axis 14. The clamping jaw 15 is thus swiveled about the axis 14 by the extension or retraction of the ram 17 of the ram-cylinder unit 18. The clamping jaw 15 also has a clamping surface 16. Opposite clamping surface 16 of clamping jaw 15, on swivel arm 11 there is a guide element 9 whose upper side forms a guide contour 8 on which the tying means is guided in a sliding motion. In the guiding position of the swivel arm 11 shown in FIG. 3, the tying means 3 consequently slides along the guide contour 8 and is additionally guided past at least one deflector 7, wherein several deflectors 7 can preferably be used here, for example to achieve tension in the tying means 3. electromagnet Furthermore, the guide contour 8 of the guide element 9 is located in the guiding position of the swivel arm 11 shown in FIG. 3, with a predominant part of the guide contour 8 on a corresponding support 29 of the device 1. In this case, the support 29 is a fixed component of the device 1. On the underside of the guide element 9 opposite the guide contour 8, a pressure surface 19 is also formed on the guide element 9, which has a geometry that is complementary to the corresponding clamping surface 16 of the clamping jaw 15. In this way, a form fit is created between the clamping surface 16 of the clamping jaw 15 and the corresponding pressure surface 19 of the guide element 9, thereby allowing the elements of the gripping device 13 to engage with each other. In the embodiment shown in FIG. 3, the tying means 3 supplied from a stock roll 24 is fed via a tube 12. If the tying means 3 is torn, it is necessary to feed a replacement tying means 3 via the tube 12, which is why it is of considerable advantage to provide a guiding device 21 in the transition area between the end of the tube 12 and the first deflector 7, the conical or tapering course of which guides the tying means 3 directly onto the surface of the deflector 7.

FIG. 4 again shows the guidance of an intact tying means 3, with the special feature here being that a further tying means 3 not shown has already been torn off. The illustration is only intended to help understand the structure of the device 1, since in the event of a single tying means 3 being torn off, the tying means 3 that has not been torn off is pretensioned by the swivel arm 11, which, as can be seen from FIG. 4, has been swiveled from its guiding position in the direction of arrow D into a tensioning position in order to exert the aforementioned pretension on the intact tying means 3. In this clamping position of the swivel arm 11 and with the intact tying means 3, the gripping device 13 is open, i.e. not activated.

FIGS. 5-10 show how the gripping device 13 according to the invention works when a tying means 3 has been torn off. FIG. 5 initially shows the swivel arm 11 still in the previously described clamping position. However, the diagram in FIG. 5 is of the swivel arm 11 from which the tying means 3 has been torn off. A replacement tying means 3 is supplied via the tube 12, the free end of which has already been inserted in a first step via the guiding device 21 and the deflector 7 into the intermediate space of the gripping device 13, i.e. between the clamping jaw 15 and the pressure surface 19 of the guide element 9. In this state, the gripping device 13 is still open, that is to say, there is a free space between the clamping jaw 15 and the associated guide element 9.

A further step in the replacement of the torn-off tying means 3 is illustrated in the diagram in FIG. 6. FIG. 6 shows the clamping position of a swivel arm 11 with a torn-off tying means 3 and with the gripping device 13 closed, which means that the gripping device 13 was activated in this step and thus the ram 17 of the ram-cylinder unit 18 was moved in the direction of arrow E, i.e. it was extended, so that the clamping jaw 15 of the gripping device 13 was pivoted in the direction of arrow F about the axis 14. As a result, the clamping surface 16 of the clamping jaw 15 comes into contact with the corresponding pressure surface 19 of the guide element 9, whereby the fed end of the tying means 3 is clamped between the pressure surface 19 and the clamping surface 16 and thus fixed in place.

As can be seen in the next step from FIG. 7, the swivel arm 11 is then returned to its guiding position, whereby the movement of the swivel arm 11 in the direction of the arrow G causes the end of the tying means 3 that is clamped in the gripping device 13 to be carried along by this movement of the swivel arm 11 in the direction of the arrow G so that it spans a free space 22 between the deflector 7 and the guiding position now occupied by the swivel arm 11.

In a subsequent step, which is shown in FIG. 8, a tying tool 6 in the form of a “tying needle” is moved vertically downwards in the direction of arrow H, as a result of which the barbed hook 26 present on the tying tool 6 is located below the tying means 3 while the gripping device 13 still fixes the free end of the tying means 3 in the guiding position of the swivel arm 11.

As apparent in the diagram in FIG. 9, the tying tool 6 is then moved vertically upwards in the direction of arrow J so that the tying means 3 is taken along in a loop by means of the barbed hook 26 present on the tying tool 6 and, with the tying means 3 thereby being fed to a suitable knotting or twisting device for tying or twisting, which, however, is not shown in FIG. 9, since it is known per se.

Finally, FIG. 10 shows the release of the tying means 3 by the gripping device 13 for further processing of the recycling bales 2 and for continuing the process of tying up the recycling bales 2. In this case, the ram 17 of the ram-cylinder unit 18 was first moved in the direction of the arrow K, so that the clamping jaw 15 of the gripping device 13 was pivoted about the axis 14 in the direction of the arrow L, which leads to the release of the gripping device 13 and thus to the release of the end of the tying means 3. The remaining piece of tying means 3 is ultimately cut off and disposed of.

### LIST OF REFERENCE SIGNS

1 Device for compressing and tying recycling bales
2 Recycling bales
3 Tying means
4 Baling channel
5 Baling ram
6 Tying tool
7 Deflector
8 Guide contour
9 Guide element
10 Axis of rotation
11 Swivel arm
12 Tube or slot
13 Gripping device
14 Axis
15 Clamping jaw
16 Clamping surface
17 Ram
18 Ram-cylinder unit
19 Pressure surface
20 Protective plate
21 Guiding device
22 Free space
23 Filling shaft
24 Stock roll
25 Machine bed
26 Barbed hook
27 Hydraulic unit
28 Ram
29 Support

1. A device for compressing and tying up recycling bales with tying means, the device comprising
a baling channel and a baling ram that is mounted in such a way that it can be moved in a translational motion in the baling channel and that has a channel on a face side for guiding a vertically movable tying tool that transports the tying means for tying up the compressed recycling bales, each tying means being guided below the baling channel around at least one deflector and over the guide contour of a respective guide element; and
at least one swivel arm that can be moved along a linear guide or is mounted in such a way that it can rotate about an axis of rotation, which, during the normal operation of the device, is in a guiding position in which the tying means, which is fed through a tube or a slot, are guided along the at least one deflector assigned to the guide contour of the guide element and over the guide contour of the guide element in a sliding motion, with the at least one swivel arm having a gripping device on the tying means side for the automated fixing of a free end of a torn-off piece of tying means.

2. A device according to claim 1, wherein a plurality of synchronously moved swivel arms form a swivel unit that can swivel along the linear guide or about a shared axis.

3. A device according to claim 2, wherein the gripping device of each swivel arm of the plurality of synchronously moved swivel arms has a clamping jaw that is mounted so that it can swivel around an axis a clamping surface of which can be activated by means of a ram of a ram-cylinder unit or of an electromagnet, with the clamping surface bearing under pressure on an underside of the guide element that is opposite the guide contour for guiding the tying means and forming a pressure surface.

4. A device according to claim 3, wherein when a tying means is torn, the swivel unit is transferred from the guiding position to a clamping position in which the swivel arms assume a position in which an intact tying means are guided under pretension over the guide contour of the guide elements and a trailing replacement tying means is clamped between the pressure surface on the underside of the guide element and the clamping surface of the clamping jaw.

5. A device according to claim 4, wherein the end of the tying means supplied via the tube or the slot and fixed in place by the gripping device is transferred by means of the swivel arm out of the clamping position back into the guiding position and can be grasped in the guiding position by means of the tying tool.

6. A device according to claim 5, wherein the end of the tying means grasped by the tying tool can be twisted or knotted by a twisting or knotting device.

7. A device according to claim 3, wherein the pressure surface on the underside of the guide element has a contour complementary to the clamping surface of the clamping jaw.

8. A device according to claim 3, wherein a form fit capable of receiving the tying means is present between the pressure surface on the underside of the guide element and the clamping surface of the clamping jaw.

9. A device according to claim 2, wherein the plurality of synchronously moved swivel arms are protected from contamination by a protective plate.

10. A device according to one claim 1, wherein a guiding device for feeding the tying means is arranged at an outlet of the tube or slot feeding the tying means for the purpose of replacing the tying means that has been torn off between the clamping jaw and the guide element.

11. A device according to claim 10, wherein the guiding device has a conical or tapering shape in the direction of the at least one swivel arms.

12. A method for tying up recycling bales using a device according to claim 4, wherein the plurality of synchronously moved swivel arms of the swivel unit, which are in a guiding position during the normal operation of the device, are transferred synchronously from the guiding position into the clamping position when at least one tying means is torn, in which clamping position the undamaged tying means continue to be guided under pretension over the guide contour of the guide elements, while the replacement tying means that is fed in is grasped and clamped in the clamping position through the activation of the gripping device between the pressure surface on the underside of the guide element and the clamping surface of the clamping jaw by a subsequent return movement of the swivel unit to the guiding position, the tying means spans a free space so that the tying tool grasps the replaced tying means by means of a vertical lifting movement and feeds it to a knotting or twisting device.

13. A method according to claim 12, wherein following the knotting or twisting, a remaining excess of the tying means is cut off and the normal operation of the device is continued.

14. A device for compressing and tying up a recycling bale with a tying means, the device comprising:
a baling channel;
a deflector located below the baling channel;
a swivel arm movable between a guiding position and a tensioning position;
a gripping device on the swivel arm, the gripping device including a clamping jaw and a guide element, the guide element having a guide contour and an underside opposite the guide contour; and
a baling ram configured to translate through the baling channel to compress the recycling bale, the baling ram having a channel for guiding a vertically movable tying tool, the tying tool configured to transport the tying means for tying up the compressed recycling bale, the tying means guided by the tying tool below the baling channel, around the deflector, and over the guide contour of the guide element,
wherein when the tying means is intact, the swivel arm remains in the guiding position and the tying means is guided by the swivel arm along the deflector and over the guide contour of the guide element in a sliding motion, and
wherein when a piece of the tying means is torn off, the gripping device clamps a free end of the torn-off piece of the tying means between the clamping jaw and underside of the guide element, and the swivel arm moves to the tensioning position.

15. A device according to claim 14, further comprising a ram-cylinder unit including a ram for moving the clamping jaw of the gripping device such that a clamping surface of the clamping jaw bears under pressure on a pressure surface on the underside of the guide element.

16. A device according to claim 15, wherein the pressure surface on the underside of the guide element has a contour complementary to the clamping surface of the clamping jaw.

17. A device according to claim 14, further comprising a protective plate positioned between the baling channel and the swivel arm to protect the swivel arm from contamination.

18. A device according to claim 14, wherein the device includes a plurality of swivel arms.

19. A device according to claim 18, further comprising a hydraulic unit configured to synchronously move the plurality of swivel arms.
